(19) United States
(12) Patent Application Publication
(10) Pub. No.: US 2015/0182894 A1
(43) Pub. Date: Jul. 2, 2015

(54) WATER FILTER ASSEMBLY

(71) Applicant: General Electric Company, Schenectady, NY (US)

(72) Inventors: Timothy Scott Shaffer, La Grange, KY (US); James Robert White, Crestwood, KY (US)

(73) Assignee: General Electric Company, Schenectady, NY (US)

(21) Appl. No.: 14/146,248

(22) Filed: Jan. 2, 2014

(51) Int. Cl. B01D 35/147; B01D 35/30

(52) U.S. Cl. CPC B01D 35/147; B01D 35/306

(57) ABSTRACT

A water filter assembly is provided. The water filter assembly includes a manifold and a fitting rotatably mounted to the manifold such that the fitting is rotatable between a substantially vertical configuration and a substantially horizontal configuration. The water filter assembly also includes a diverting member and a handle mounted to the diverting member. The handle is positioned opposite the fitting on the manifold.

### FIELD OF THE INVENTION

The present subject matter relates generally to water filters, such as point of entry water filters.

### BACKGROUND OF THE INVENTION

Water filters are generally divided into two classes: point of entry water filters and point of use water filters. Point of entry water filters can be installed on a water line in order to filter water flowing through the water line into a building or residence. Thus, point of entry water filters can provide filtered water throughout the building or residence.

Installing point of entry water filters on the water line can be difficult. Generally, point of entry water filters are configured for installation on water lines with a particular orientation, such as a vertical orientation or a horizontal orientation. However, water lines can be oriented in a variety of directions within a building or residence. If the water line is not arranged in the particular orientation, a plumber or other installer reconfigures the water line. Such reconfiguration can require time consuming operations, such as cutting and brazing joints on copper water lines or cutting or gluing joints on PVC water lines.

Point of entry water filters can also include features for permitting water to bypass a filter medium of the water filter. Generally, a handle is provided to actuate between a filtering configuration and a bypass configuration. The handle can be difficult to actuate depending upon a location and orientation of the water line and handle.

Accordingly, a water filter assembly with features for assisting with coupling the water filter assembly to a water line in a variety of orientations would be useful. In addition, a water filter assembly with features for assisting with actuating between a filtering configuration and a bypass configuration would be useful.

### BRIEF DESCRIPTION OF THE INVENTION

The present subject matter provides a water filter assembly. The water filter assembly includes a manifold and a fitting rotatably mounted to the manifold such that the fitting is rotatable between a substantially vertical configuration and a substantially horizontal configuration. The water filter assembly also includes a diverting member and a handle mounted to the diverting member. The handle is positioned opposite the fitting on the manifold. Additional aspects and advantages of the invention will be set forth in part in the following description, or may be apparent from the description, or may be learned through practice of the invention.

In a first exemplary embodiment, a water filter assembly is provided. The water filter assembly includes a bracket and a manifold mounted to the bracket. The manifold includes a body that defines an inlet conduit and an outlet conduit. A fitting is rotatably mounted to the body such that the fitting is rotatable between a substantially vertical configuration and a substantially horizontal configuration. The fitting defines an entrance and an exit. The entrance of the fitting is in fluid communication with the inlet conduit of the body. The exit of the fitting is in fluid communication with the outlet conduit of the body. A diverting member is positioned within the body. A handle is mounted to the diverting member. The handle is positioned opposite the fitting on the body. A casing is removably mounted to the manifold. The casing defines an interior volume. The interior volume of the casing is in selective fluid communication with the inlet and outlet conduits depending upon a position of the handle. A filter medium is positioned within the interior volume of the casing.

In a second exemplary embodiment, a water filter assembly is provided. The water filter assembly includes a bracket and a manifold mounted to the bracket. The manifold includes a body that defines an inlet conduit and an outlet conduit. A fitting includes a hub rotatably mounted to the body. An entrance conduit is mounted to the hub and extends away from the hub to an entrance. The entrance of the entrance conduit is in fluid communication with the inlet conduit of the body. An exit conduit is also mounted to the hub and extends away from the hub to an exit. The exit of the exit conduit is in fluid communication with the outlet conduit of the body. The exit conduit is positioned opposite the entrance conduit on the hub. The fitting also includes a pair of slip fit connectors. A respective one of the pair of slip fit connectors is positioned at the entrance and exit conduits. A diverting member is positioned within the body. A handle is mounted to the diverting member. The handle is positioned opposite the fitting on the body. A casing is removably mounted to the manifold. The casing defines an interior volume. The interior volume of the casing is in selective fluid communication with the inlet and outlet conduits depending upon a position of the diverting member. A filter medium is positioned within the interior volume of the casing.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water filter assembly according to an exemplary embodiment of the present subject matter.

FIG. 2 provides an exploded view of the exemplary water filter assembly of FIG. 1.

FIG. 3 provides a perspective view of the exemplary water filter assembly of FIG. 1 in a horizontal configuration.

FIG. 4 provides a perspective view of the exemplary water filter assembly of FIG. 1 in a vertical configuration.

FIGS. 5, 6, 7 and 8 provide section views of a hub of the exemplary water filter assembly of FIG. 1 in various stages of being mounted to a pipe.

FIGS. 9, 10 and 11 provide section views of the exemplary water filter assembly of FIG. 1 with a handle of the exemplary water filter assembly shown in various positions.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

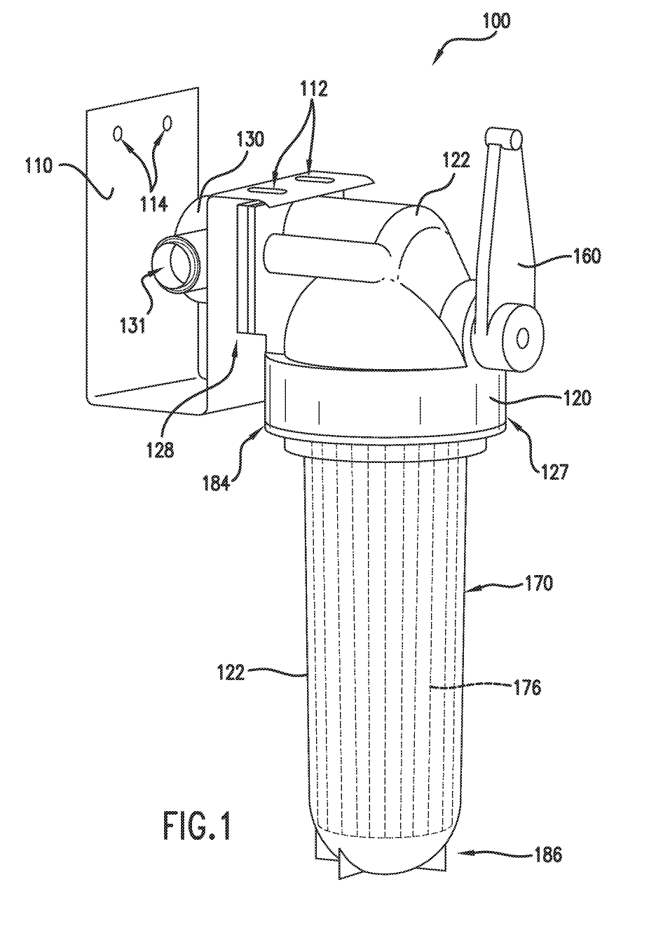

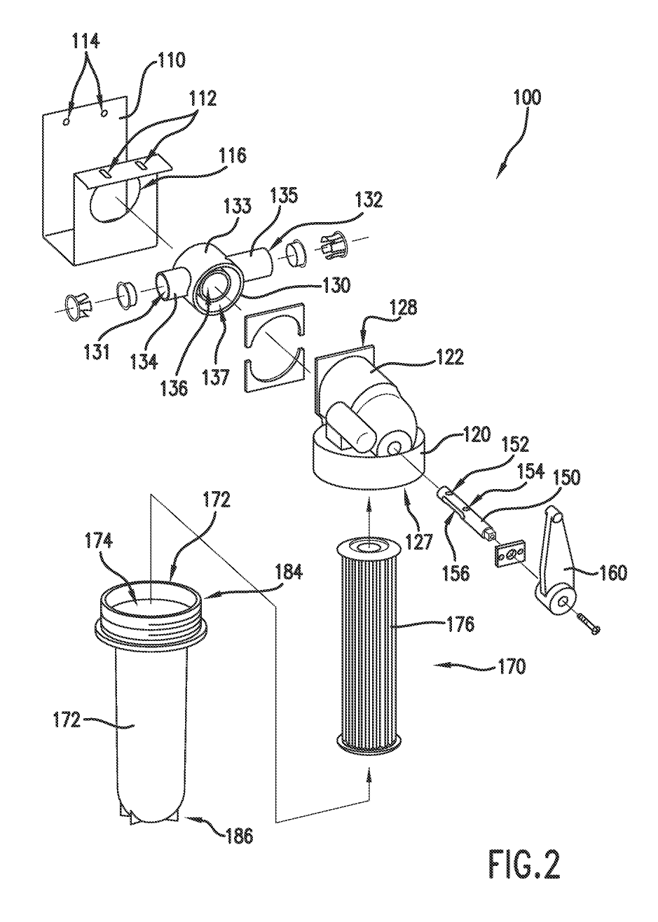

FIG. 1 provides a perspective view of a water filter assembly 100 according to an exemplary embodiment of the present subject matter. FIG. 2 provides an exploded view of water filter assembly 100. Water filtering assembly 100 is configured for selectively filtering water coming into a building or residence from a water supply, such as a municipal water source or a well. Water filtering assembly 100 can remove contaminants such as chlorine, chloroform, lead, arsenic, pharmaceuticals, microbes, and/or other undesirable substances from water flowing therethrough. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances. Water filtering assembly 100 can be installed at any suitable location within the building or residence. For example, water filter assembly 100 may be installed beneath a sink or within a basement, supply closet, etc.

Water filtering assembly 100 includes a bracket 110, a manifold 120 and a water filter 170. Bracket 110 is mountable to a wall. Bracket 110 defines holes 114. Fasteners (not shown) such as nails, pegs, tabs, screws, bolts, etc. may be inserted through holes 114 to mount water filtering assembly 100, e.g., to a kitchen cabinet beneath a kitchen sink, or to a wall within a house.

Manifold 120 is mounted to bracket 110. A position of manifold 120 relative to bracket 110 is selectively adjustable. In particular, bracket 110 defines slots 112. A fastener (not shown), such as a screw, bolt, etc., extends through each slot of slots 112 into manifold 120 in order to couple manifold 120 to bracket 110. Slots 112 permit the position of manifold 120 relative to bracket 110 to be selectively adjustable. For example, the fasteners can slide within slots 112, and a user can secure the fastener within slots 112 to fix the position of manifold 120 relative to bracket 110. Slots 112 can permit any suitable movement of manifold 120 relative to bracket 110. For example, slots 112 can extend by about half an inch in order to permit manifold 120 to move by about half an inch relative to bracket 110.

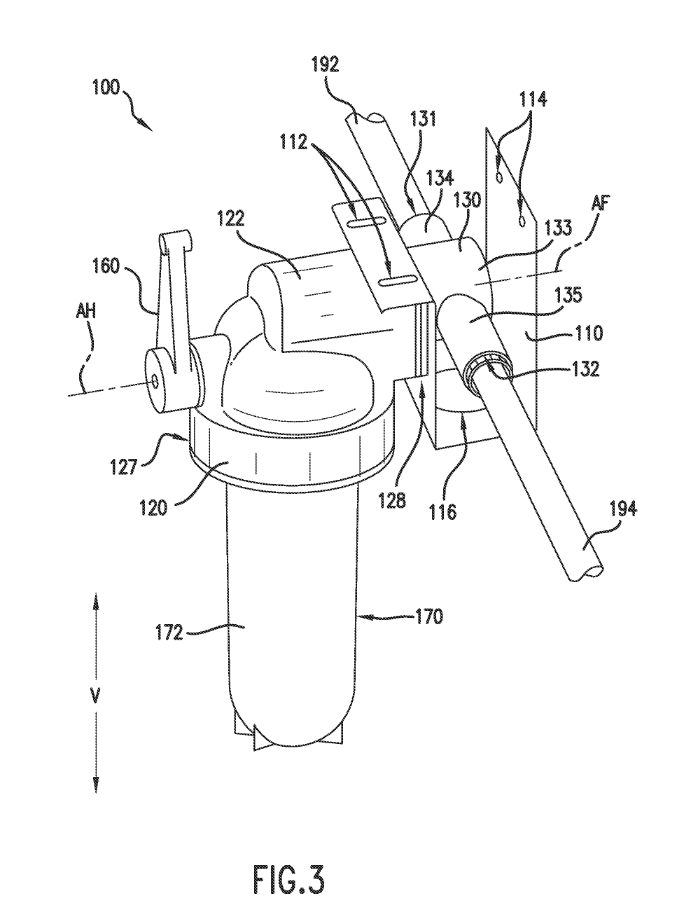

Manifold 120 includes a body 122, a fitting 130, a diverting member 150 and a handle 160. Body 122 defines an inlet conduit 124 (FIG. 9) and an outlet conduit 126 (FIG. 9). Fitting 130 is rotatably mounted to body 122. Fitting 130 defines an entrance 131 and an exit 132. Entrance 131 of fitting 130 is in fluid communication with inlet conduit 124 of body 122. Exit 132 of fitting 130 is in fluid communication with outlet conduit 126 of body 122. Entrance 131 of fitting 130 may be in fluid communication with a water supply via an inlet pipe 192 (FIG. 3) and receive unfiltered water from the water supply. From entrance 131, such unfiltered water is directed into water filter 170 via inlet conduit 124 of body 122. Such unfiltered water passes through water filter 170 and exits water filter 170 via outlet conduit 126 of body 122 as filtered water. From outlet conduit 126, such filtered water exits manifold 120 via exit 132 of fitting 130. Such filtered water may, e.g., be directed to an ice maker or dispenser of a refrigerator appliance, a kitchen sink faucet, and/or any other suitable outlet via outlet pipe 194 (FIG. 3).

Diverting member 150 is positioned within body 122, and handle 160 is mounted or coupled to diverting member 150. Handle 160 is positioned opposite fitting 130 on body 122. In particular, body 122 extends between a front portion 127 and a back portion 128. Fitting 130 is positioned at or adjacent back portion 128 of body 122, and handle 160 is positioned at or adjacent front portion 127 of body 122.

Water filter 170 of water filtering assembly 100 includes a casing 172 that defines an interior volume 174. Casing 172 also extends between a top portion 184 and a bottom portion 186. Casing 172 defines an opening 178 at top portion 184 of casing 172. Opening 178 of casing 172 permits access to interior volume 174 of casing 172. Casing 172 is removably mounted, e.g., threaded, to body 122 of manifold 120. Interior volume 174 of casing 172 is in selective fluid communication with inlet and outlet conduits 124 and 126 of body 122, e.g., depending upon a position of handle 160, as discussed in greater detail below.

A filtering medium 176 is disposed within interior volume 174 of casing 172. Filtering medium 176 also divides interior volume 174 of casing 172 into an unfiltered portion 180 (FIG. 9) and a filtered portion 182 (FIG. 9). Filtering medium 176 can remove impurities and contaminants from water passing through filtering medium 176 from unfiltered portion 180 to filtered portion 182. Filtering medium 176 may include any suitable mechanism for filtering water such as, e.g., ceramic filters, activated carbon filters, polymer filters, reverse osmosis filters, etc.

As used herein, the term “unfiltered” describes a volume within interior volume 174 that is not filtered relative to filtering medium 176. However, as will be understood by those skilled in the art, water filtering assembly 100 may include additional filters that filter water entering interior volume 174. Thus, “unfiltered volume” may be filtered relative to other filters but not filtering medium 176.

As an example, water passing though water filtering assembly 100 can follow a path through water filtering assembly 100. In particular, unfiltered water can enter water filtering assembly 100 through entrance 131 of fitting 130. Such unfiltered water can then flow into unfiltered portion 180 of interior volume 174. Such unfiltered water can pass though filtering medium 176 to remove impurities and can exit filtering medium 176 into filtered portion 182 of interior volume 174 as filtered water. Such filtered water can then exit water filtering assembly 100 through exit 132 of fitting 130. In such a manner, unfiltered water can follow the path through water filtering assembly 100. In particular, unfiltered water can pass though filtering medium 176, and filtered water can exit water filtering assembly 100. Such filtering can improve taste and/or safety of water.

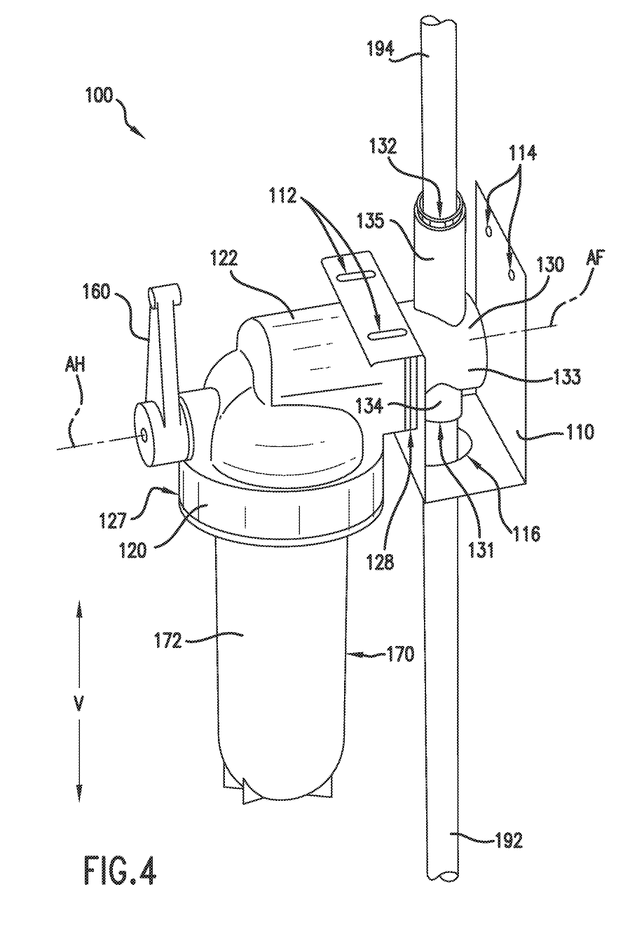

FIG. 3 provides a perspective view of water filter assembly 100 in a horizontal configuration. FIG. 4 provides a perspective view of water filter assembly 100 in a vertical configuration. As discussed above, fitting 130 is rotatably mounted to body 122. Thus, fitting 130 is rotatable about an axis of rotation AF of fitting 130. In particular, as may be seen in FIGS. 3 and 4, fitting 130 is rotatably mounted to body 122 such that fitting 130 is rotatable or pivotable between a substantially horizontal configuration (FIG. 3) and a substantially vertical configuration (FIG. 4), e.g., about the axis of rotation AF of fitting 130. Rotation of fitting 130, e.g., relative to body 122, can permit fitting 130 to be mounted to a horizontally oriented pipe as shown in FIG. 3 or a vertically oriented pipe as shown in FIG. 4. In such a manner, water filter assembly 100 can be installed in a variety of locations and/or to a variety of pipes, e.g., without requiring reconfiguration of the pipes. In particular, fitting 130 can be rotated to an suitable orientation rather than reconfiguring associated pipes.

As may be seen in FIG. 4, bracket 110 defines an opening 116. Opening 116 is sized for permitting outlet pipe 194, e.g., or inlet pipe 192, to pass through opening 116 of bracket 110 to fitting 130. Thus, when outlet pipe 194 is vertically oriented, opening 116 of bracket 110 can permit outlet pipe 194 to pass through bracket 110 to fitting 130.

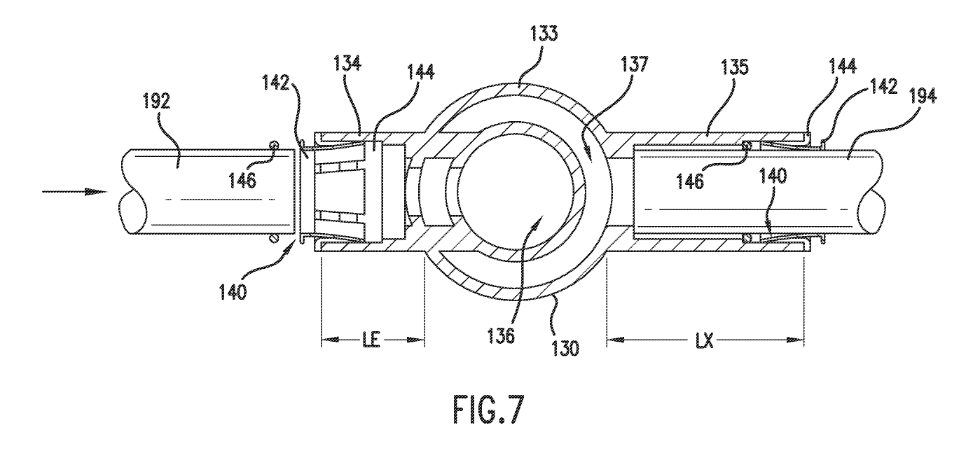

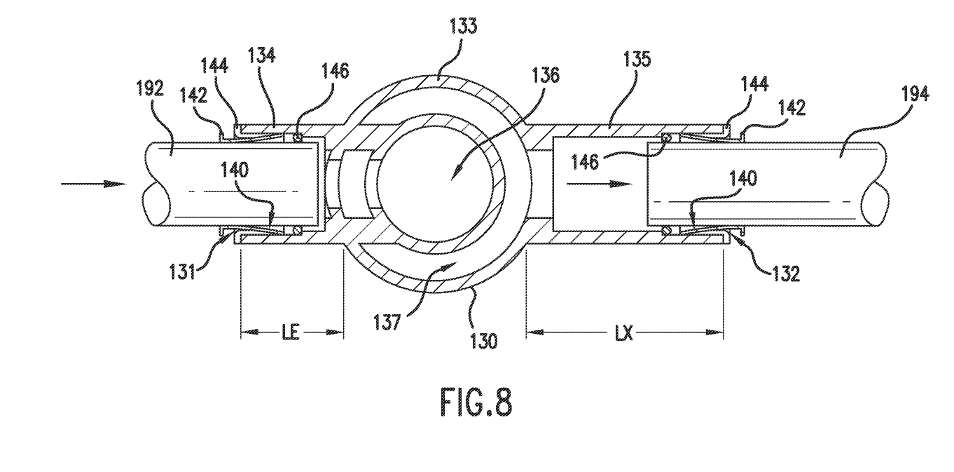

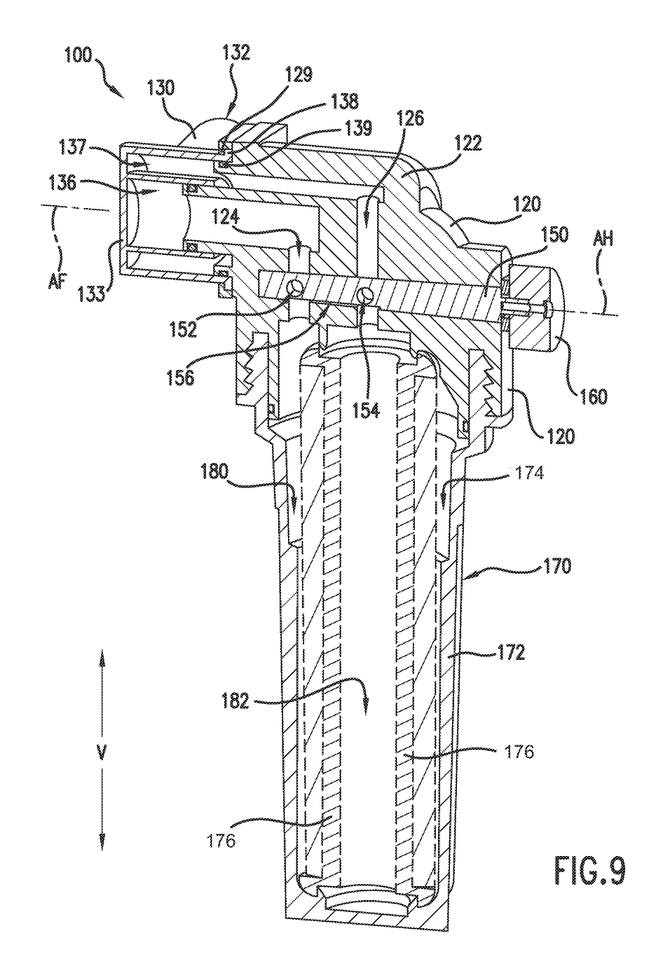

FIGS. 5, 6, 7 and 8 provide section views of a hub 133 of manifold 120 in various stages of being mounted to a pipe 190. As may be seen in FIGS. 7 and 8, fitting 130 include hub 133, an entrance conduit 134 and an exit conduit 135. Entrance conduit 134 and exit conduit 135 are mounted to hub 133. Exit conduit 135 is positioned opposite entrance conduit 134 on hub 133. In addition, entrance conduit 134 and exit conduit 135 may be positioned substantially concentric to each other.

Hub 133 defines a first volume 136 and a second volume 137. First volume 136 of hub 133 is in fluid communication with entrance conduit 134 such that water is directed from entrance conduit 134 into first volume 136 of hub 133. Conversely, second volume 137 of hub 133 is in fluid communication with exit conduit 135 such that water is directed from second volume 137 of hub 133 into exit conduit 135. Second volume 137 extends about first volume 136, e.g., in a plane that is perpendicular to axis of rotation AF (FIG. 3) of fitting 130.

Entrance conduit 134 of fitting 130 extends away from hub 133, e.g., to entrance 131 of fitting 130, by a length LE. Similarly, exit conduit 135 of fitting 130 extends away from hub 133, e.g., to exit 132 of fitting 130, by a length LX. The length LE of entrance conduit 134 and the length LX of exit conduit 135 can be any suitable lengths. In certain exemplary embodiments, the length LE of entrance conduit 134 may be different than the length LX of exit conduit 135. For example, the length LX of exit conduit 135 may be more than about twice the length LE of entrance conduit 134. As another example, the length LE of entrance conduit 134 may be more than about twice the length LX of exit conduit 135.

Fitting 130 also includes a pair of slip fit connectors 140. Slip fit connectors 140 are positioned at entrance and exit conduits 134 and 135 of fitting 130. Slip fit connectors 140 include grommets 142, cartridges 144 and O-rings 146. Slip fit connects 140 permit coupling or mounting of fitting 130 to inlet and outlet pipes 192 and 194, e.g., without adhesive or brazing.

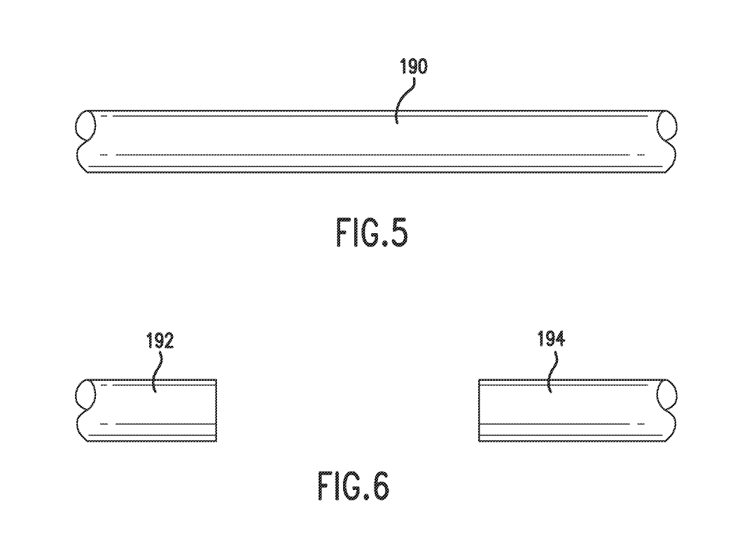

Mounting of fitting 130 to pipe 190 is discussed in greater detail below with reference to FIGS. 5, 6, 7 and 8. Turning to FIGS. 5 and 6, an installer can cut pipe 190 and remove a section of pipe 190 to provide inlet pipe 192 and outlet pipe 194. About a four inch section of pipe 190 can be removed to provide inlet pipe 192 and outlet pipe 194.

Turning now to FIG. 7, outlet pipe 194 is inserted into exit conduit 135 and slip fit connector 140 at exit conduit 135. Grommet 142 and cartridge 144 of slip fit connector 140 can assist with coupling fitting 130 to outlet pipe 194, and O-ring 146 can assist with limiting or preventing water from leaking out of fitting 130 and/or outlet pipe 194. As may be seen in FIG. 7, outlet pipe 194 is inserted into exit conduit 135 such that outlet pipe 194 extends along about the length LX of exit conduit 135 within exit conduit 135. Such full insertion can permit inlet pipe 192 to be aligned with entrance conduit 134 at the opposite side of fitting 130.

Turning now to FIG. 8, inlet pipe 192 is inserted into entrance conduit 134 and slip fit connector 140 at entrance conduit 134. Grommet 142 and cartridge 144 of slip fit connector 140 can assist with coupling fitting 130 to inlet pipe 192, and O-ring 146 can assist with limiting or preventing water from leaking out of fitting 130 and/or inlet pipe 192. As may be seen in FIG. 8, inlet pipe 192 is inserted into entrance conduit 134 such that inlet pipe 192 extends along about the length LE of entrance conduit 134 within entrance conduit 134. With inlet pipe 192 so positioned, outlet pipe 194 is only partially inserted into exit conduit 135. Thus, outlet pipe 194 does not extend along about the length LX of exit conduit 135 within exit conduit 135 when fitting 130 is mounted to both inlet pipe 192 and outlet pipe 194.

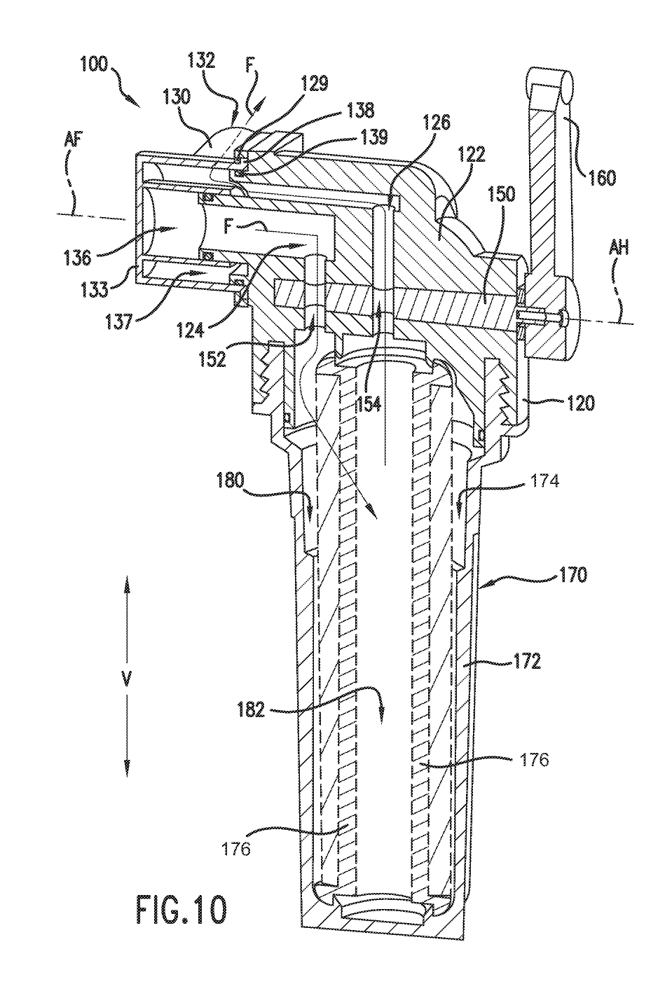

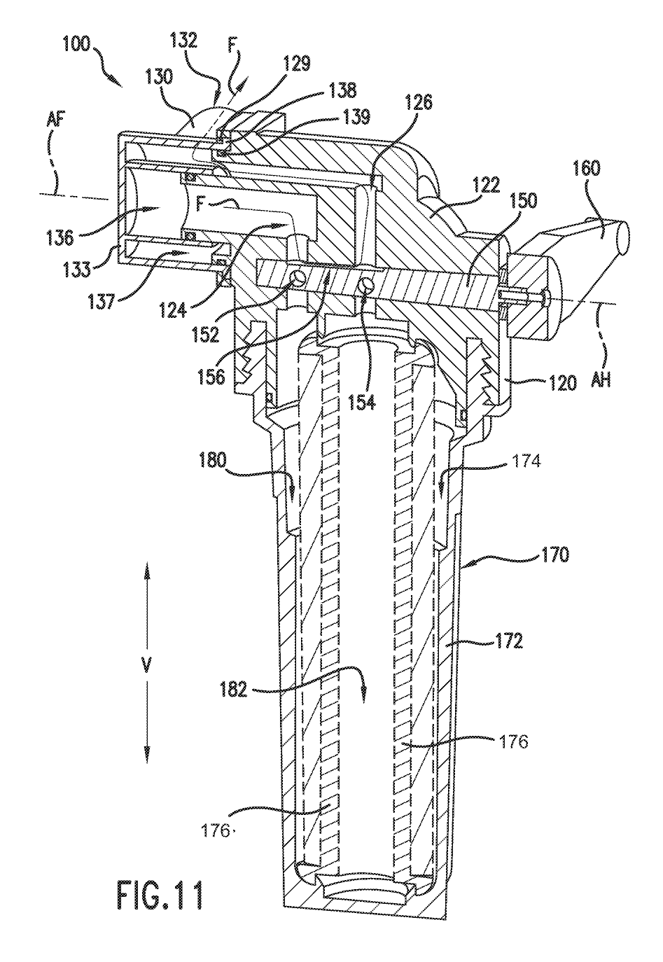

FIGS. 9, 10 and 11 provide section views of water filter assembly 100 with diverting member 150 and handle 160 of water filter assembly 100 shown in various positions. In FIG. 9, diverting member 150 and handle 160 of water filter assembly 100 are shown in a first position such that water filter assembly 100 is in a no flow configuration. In FIG. 10, diverting member 150 and handle 160 of water filter assembly 100 are shown in a second position such that water filter assembly 100 is in a filtered water configuration. In FIG. 11, diverting member 150 and handle 160 of water filter assembly 100 are shown in a third position such that water filter assembly 100 is in a bypass configuration.

Diverting member 150 and handle 160 are rotatable about an axis of rotation AH between the first, second and third positions. The axis of rotation AH of handle 160 may be substantially parallel to the axis of rotation AF of fitting 130. In addition, the axis of rotation AH of handle 160 and/or the axis of rotation AF of fitting 130 may be substantially perpendicular to a vertical direction V. A user can adjust water filter assembly 100 between the no flow configuration (FIG. 9), the filtered water configuration (FIG. 10) and the bypass configuration (FIG. 11) by rotating handle 160 about the axis of rotation AH as discussed in greater detail below.

As may be seen in FIG. 9, diverting member 150 is disposed between inlet and outlet conduits 124 and 126 of body 122 and interior volume 174 of casing 172 when diverting member 150 and handle 160 are in the first position. Thus, diverting member 150 obstructs or hinders fluid flow from inlet conduit 124 to interior volume 174 of casing 172 and/or outlet conduit 126 when diverting member 150 and handle 160 are in the first position. Thus, water does not flow through water filter assembly 100 in the no flow configuration.

Turning now to FIG. 10, diverting member 150 defines an inlet passage 152 and an outlet passage 154. Interior volume 174 of casing 172 (e.g., unfiltered portion 180 of interior volume 174) is in fluid communication with inlet conduit 124 of body 122 via inlet passage 152 of diverting member 150 when diverting member 150 and handle 160 are in the second position as shown in FIG. 9. Thus, inlet conduit 124 of body 122 is aligned with inlet passage 152 of diverting member 150 when diverting member 150 and handle 160 are in the second position. In addition, interior volume 174 of casing 172 (e.g., filtered portion 182 of interior volume 174) is in fluid communication with outlet conduit 126 of body 122 via outlet passage 154 of diverting member 150 when diverting member 150 and handle 160 are in the second position as shown in FIG. 9. Thus, outlet conduit 126 of body 122 is aligned with outlet passage 154 of diverting member 150 when diverting member 150 and handle 160 are in the second position.

In the second position, diverting member 150 permits fluid flow (shown with arrows F) from inlet conduit 124 into interior volume 174 of casing 172 and fluid flow F from interior volume 174 of casing 172 to outlet conduit 126. In such a manner, filtered water flows out of exit 132 of fitting 130 in the filtered water configuration. As an example, a user can adjust water filter assembly 100 from the no flow configuration (FIG. 9) to the filtered water configuration (FIG. 10) by rotating handle 160 about the axis of rotation AH of handle 160 from the first position (FIG. 9) to the second position (FIG. 10).

Turning now to FIG. 11, diverting member 150 also defines a bypass 156. Diverting member 150 is disposed between inlet conduit 124 of body 122 and interior volume 174 of casing 172 (e.g., unfiltered portion 180 of interior volume 174) when diverting member 150 and handle 160 are in the third position. In addition, diverting member 150 is disposed between outlet conduit 126 of body 122 and interior volume 174 of casing 172 (e.g., filtered portion 182 of interior volume 174) when diverting member 150 and handle 160 are in the third position. However, inlet and outlet conduits 124 and 126 of body 122 are in fluid communication with each other via bypass 156 when diverting member 150 and handle 160 are in the third position. Thus, bypass 156 of diverting member 150 extends between inlet and outlet conduits 124 and 126 of body 122 when diverting member 150 and handle 160 are in the third position.

Unfiltered water flows out of exit 132 of fitting 130 and bypasses water filter 170 in the bypass configuration. As an example, a user can adjust water filter assembly 100 from the filtered water configuration (FIG. 10) to the bypass configuration (FIG. 11) by rotating handle 160 about the axis of rotation AH of handle 160 from the second position (FIG. 10) to the third position (FIG. 11).

As discussed above, fitting 130 is rotatably mounted to manifold 120. In particular, as may be seen in FIG. 9, hub 133 includes a, e.g., circular, flange 138. In addition, body 122 also includes a, e.g., circular, flange 129. Flange 138 of hub 133 engages flange 129 of body 122 to rotatably mount fitting 130 to manifold 120. A seal 139 extends between hub 133 and body 122 adjacent where flange 138 of hub 133 engages flange 129 of body 122. Seal 139 can assist with limiting or preventing leaks as such location.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water filter assembly, comprising:
a bracket;
a manifold mounted to the bracket, the manifold comprising
a body defining an inlet conduit and an outlet conduit;
a fitting rotatably mounted to the body such that the fitting is rotatable between a substantially vertical configuration and a substantially horizontal configuration, the fitting defining an entrance and an exit, the entrance of the fitting being in fluid communication with the inlet conduit of the body, the exit of the fitting being in fluid communication with the outlet conduit of the body;
a diverting member positioned within the body; and
a handle mounted to the diverting member, the handle positioned opposite the fitting on the body;
a casing removably mounted to the manifold, the casing defining an interior volume, the interior volume of the casing in selective fluid communication with the inlet and outlet conduits depending upon a position of the handle; and
a filter medium positioned within the interior volume of the casing.

2. The water filter assembly of claim 1, wherein the diverting member defines an inlet passage, an outlet passage and a bypass, the interior volume of the casing being in fluid communication with the inlet conduit of the body via the inlet passage of the diverting member and the outlet conduit of the body via the outlet passage of the diverting member when the handle is in a first position, the diverting member disposed between the inlet and outlet conduits of the body and the interior volume of the casing when the handle is in a second position, the inlet conduit of the body being in fluid communication with the outlet conduit of the body via the bypass when the handle is in a third position.

3. The water filter assembly of claim 1, wherein the handle is rotatable in an axis of rotation and the fitting is rotatable about an axis of rotation, the axis of rotation of the handle being substantially parallel to the axis of rotation of the fitting.

4. The water filter assembly of claim 1, wherein the body extends between a front portion and a back portion, the fitting positioned at the back portion of the body, the handle positioned at the front portion of the body.

5. The water filter assembly of claim 1, wherein the fitting comprises
a hub;
an entrance conduit mounted to the hub;
an exit conduit mounted to the hub and positioned opposite the entrance conduit on the hub; and
a pair of slip fit connectors, a respective one of the pair of slip fit connectors positioned at the entrance and exit conduits.

6. The water filter assembly of claim 5, wherein the entrance conduit and the exit conduit are substantially concentric to each other.

7. The water filter assembly of claim 5, wherein the entrance conduit extends away from the hub by a length and the exit conduit extends away from the hub by a length, the length of the entrance conduit being different than the length of the exit conduit.

8. The water filter assembly of claim 7, wherein the length of the entrance conduit is more than about twice the length of the exit conduit.

9. The water filter assembly of claim 7, wherein the length of the entrance conduit is less than about half the length of the exit conduit.

10. The water filter assembly of claim 5, wherein the hub defines a first volume and a second volume, the second volume extending about the first volume in a plane that is perpendicular to an axis of rotation of the fitting.

11. The water filter assembly of claim 5, wherein the hub includes a flange that engages a flange of the body, a seal extending between the hub and the body adjacent where the flange of the hub engages the flange of the body.

12. The water filter assembly of claim 1, further comprising a plurality of fasteners, wherein the bracket defines a plurality of slots, each fastener of the plurality of fasteners extending through a respective one of the plurality of slots into the body, the slots permitting a position of the manifold relative to the bracket to be selectively adjustable.

13. The water filter assembly of claim 1, wherein the bracket defines an opening, the opening sized for permitting a pipe to pass through the opening to the fitting.

14. A water filter assembly, comprising:
a bracket;
a manifold mounted to the bracket, the manifold comprising
a body defining an inlet conduit and an outlet conduit;
a fitting comprising
a hub rotatably mounted to the body;
an entrance conduit mounted to the hub and extending away from the hub to an entrance, the entrance of the entrance conduit being in fluid communication with the inlet conduit of the body;
an exit conduit mounted to the hub and extending away from the hub to an exit, the exit of the exit conduit being in fluid communication with the outlet conduit of the body, the exit conduit positioned opposite the entrance conduit on the hub; and
a pair of slip fit connectors, a respective one of the pair of slip fit connectors positioned at the entrance and exit conduits;
a diverting member positioned within the body; and
a handle mounted to the diverting member, the handle positioned opposite the fitting on the body;
a casing removably mounted to the manifold, the casing defining an interior volume, the interior volume of the casing in selective fluid communication with the inlet and outlet conduits depending upon a position of the diverting member; and
a filter medium positioned within the interior volume of the casing.

15. The water filter assembly of claim 14, wherein the diverting member defines an inlet passage, an outlet passage and a bypass, the interior volume of the casing being in fluid communication with the inlet conduit of the body via the inlet passage of the diverting member and the outlet conduit of the body via the outlet passage of the diverting member when the handle is in a first position, the diverting member disposed between the inlet and outlet conduits of the body and the interior volume of the casing when the handle is in a second position, the inlet conduit of the body being in fluid communication with the outlet conduit of the body via the bypass when the handle is in a third position.

16. The water filter assembly of claim 14, wherein the handle is rotatable in an axis of rotation and the fitting is rotatable about an axis of rotation, the axis of rotation of the handle being substantially parallel to the axis of rotation of the fitting.

17. The water filter assembly of claim 14, wherein the body extends between a front portion and a back portion, the fitting positioned at the back portion of the body, the handle positioned at the front portion of the body.

18. The water filter assembly of claim 14, wherein the entrance conduit and the exit conduit are substantially concentric to each other.

19. The water filter assembly of claim 14, wherein the entrance conduit extends away from the hub by a length and the exit conduit extends away from the hub by a length, the length of the entrance conduit being different than the length of the exit conduit.
